(19) United States
(12) Patent Application Publication
(10) Pub. No.: US 2008/0088979 A1
(43) Pub. Date: Apr. 17, 2008

(54) Head slider including heater causing expansion of lower shielding layer

(75) Inventor: Chiharu Nakata, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: Fujitsu Limited, Kawasaki-shi (JP)

(21) Appl. No.: 11/788,976

(22) Filed: Apr. 23, 2007

(30) Foreign Application Priority Data
Oct. 17, 2006 (JP) 2006-282220

(51) Int. Cl. G11B 5/127; G11B 5/33

(52) U.S. Cl. 360/313

(57) ABSTRACT

A head slider includes upper and lower shielding layers embedded in an insulating non-magnetic film overlaid on the outflow end surface of a slider body. A magnetoresistive film is embedded between the lower and upper shielding layers. A heating wiring pattern is located at the back of the lower shielding layer. The heating wiring pattern gets heated in response to the supply of electric current. This results in expansion of the lower shielding layer in front of the heating wiring pattern. The lower shielding layer is forced to protrude toward the recording medium. The lower shielding layer gets closer to the recording medium at a position upstream of the magnetoresistive film. The head slider allows the lower shielding layer to contact with the recording medium at a position upstream of the magnetoresistive film.

### BACKGROUND OF THE INVENTION

1. Field of the Invention

The present invention relates to ahead slider incorporated in a storage medium drive such as a hard disk drive, HDD.

2. Description of the Prior Art

A head slider includes a slider body and an insulating non-magnetic film overlaid on the outflow end surface of the slider body, as disclosed in Japanese Patent Application Publication No. 2006-053973. An electromagnetic transducer is embedded in the insulating non-magnetic film. A resistive element is embedded between the electromagnetic transducer and the slider body. The resistive element gets heated in response to supply of electric current. This results in expansion of the insulating non-magnetic film. The electromagnetic transducer is thus forced to protrude toward a magnetic recording disk.

The electromagnetic transducer includes a read head. The resistive element is located between the read head and the slider body. The resistive element is located at a position adjacent to the read head. The read head is thus forced to significantly protrude when the resistive element gets heated. The magnetoresistive film of the read head sometimes suffers from collision against the magnetic recording disk. The collision causes damages on the magnetoresistive film.

### SUMMARY OF THE INVENTION

It is accordingly an object of the present invention to provide a head slider and a storage medium drive capable of reliably preventing damages to a magnetoresistive film.

According to a first aspect of the present invention, there is provided a head slider comprising: a slider body; an insulating non-magnetic film overlaid on the outflow end surface of the slider body, the insulating non-magnetic film defining a medium-opposed surface opposed to a recording medium at a distance; a lower shielding layer embedded in the insulating non-magnetic film, the lower shielding layer having the front end exposed at the medium-opposed surface of the insulating non-magnetic film, the lower shielding layer extending backward from the front end along a first imaginary plane intersecting with the medium-opposed surface; an upper shielding layer embedded in the insulating non-magnetic film at a position downstream of the lower shielding layer, the upper shielding layer extending along a second imaginary plane parallel to the first imaginary plane; a magnetoresistive film embedded in the insulating non-magnetic film between the lower and upper shielding layers; and a heating wiring pattern embedded in the insulating non-magnetic film at the back of the lower shielding layer.

The heating wiring pattern is embedded in the insulating non-magnetic film at the back of the lower shielding layer in the head slider. The heating wiring pattern gets heated in response to the supply of electric current to the heating wiring pattern. This results in expansion of the lower shielding layer in front of the heating wiring pattern. The lower shielding layer is forced to protrude toward the recording medium in this manner. The lower shielding layer gets closer to the recording medium at a position upstream of the magnetoresistive film. Even if the head slider collides against the recording medium, the head slider allows the lower shielding layer to contact with the recording medium. Since the magnetoresistive film is located at a position downstream of the lower shielding layer, the magnetoresistive film is prevented from receiving damages.

The head slider may further comprise: a recess formed on the medium-opposed surface of the insulating non-magnetic film, the front end of the lower shielding layer being exposed in the recess; and a protection film formed on the surface of the insulating non-magnetic film, the protection film having an outer exposed flat surface. The recess serves to bring the front end of the lower shielding layer backward from the medium-opposed surface. The protection film is allowed to have a larger thickness within the recess rather than the protection film outside the recess. The front end of the lower shielding layer is thus covered with the thicker portion of the protection film. Even if the lower shielding layer protrudes to contact with the magnetic recording medium, the lower shielding layer is prevented from protruding out of the medium-opposed surface. The lower shielding layer is thus prevented from receiving damages. The head slider may be employed in a storage medium drive, for example.

According to a second aspect of the present invention, there is provided a head slider comprising: a slider body; an insulating non-magnetic film overlaid on the outflow end surface of the slider body; a lower shielding layer embedded in the insulating non-magnetic film; an upper shielding layer embedded in the insulating non-magnetic film at a position downstream of the lower shielding layer, the upper shielding layer extending in parallel with the lower shielding layer; a magnetoresistive film embedded in the insulating non-magnetic film between the lower and upper shielding layers; and a heating wiring pattern embedded in the insulating non-magnetic film to cause expansion of only the lower shielding layer.

The head slider allows expansion of only the lower shielding layer with the assistance of the heating wiring pattern. This results in protrusion of only the lower shielding layer toward a recording medium. The lower shielding layer gets closer to the recording medium at a position in front of the magnetoresistive film in the same manner as described above. Even if the head slider contact with the recording medium, the head slider allows the lower shielding layer to contact with the recording medium. Since the magnetoresistive film is located at a position downstream of the lower shielding layer, the magnetoresistive film is prevented from receiving damages.

The head slider may further comprise: a recess formed on the surface of the insulating non-magnetic film, the front end of the lower shielding layer being exposed in the recess; and a protection film formed on the surface of the insulating non-magnetic film, the protection film having an outer exposed flat surface. The front end of the lower shielding layer is covered with the thicker portion of the protection film in the same manner as described above. Even if the lower shielding layer protrudes to contact with the magnetic recording medium, the lower shielding layer is prevented from protruding out of the surface of the insulating non-magnetic film. The lower shielding layer is thus prevented from receiving damages. The head slider may be employed in a storage medium drive, for example.

According to a third aspect of the present invention, there is provided ahead slider comprising: a slider body; an insulating non-magnetic film overlaid on the outflow end surface of the slider body; a lower shielding layer embedded in the insulating non-magnetic film; an upper shielding layer embedded in the insulating non-magnetic film at a position downstream of the lower shielding layer, the upper shielding extending in parallel with the lower shielding layer; a magnetoresistive film embedded in the insulating non-magnetic film between the lower and upper shielding layers; a write head embedded in the insulating non-magnetic film at a position downstream of the upper shielding layer; a first heating wiring pattern embedded in the insulating non-magnetic film to cause expansion of the write head; and a second heating wiring pattern embedded in the insulating non-magnetic film to cause expansion of the lower shielding layer.

The head slider allows expansion of the write head with the assistance of the first heating wiring pattern. This results in protrusion of the write head toward a recording medium. The write head is allowed to write magnetic bit data onto the recording medium with a higher accuracy. Likewise, the second heating wiring pattern serves to cause expansion of the lower shielding layer. This results in protrusion of the lower shielding layer toward the recording medium. The lower shielding layer gets closer to the recording medium in front of the magnetoresistive film in the same manner as described above. Even if the head slider contacts with the recording medium, the head slider allows the lower shielding layer to contact with the recording medium. Since the magnetoresistive film is located at a position downstream of the lower shielding layer, the magnetoresistive film is prevented from receiving damages. The head slider may be employed in a storage medium drive, for example.

According to a fourth aspect of the present invention, there is provided a head slider comprising: a slider body; an insulating non-magnetic film overlaid on the outflow end surface of the slider body; a head element embedded in the insulating non-magnetic film; a heating wiring pattern embedded in the insulating non-magnetic film at a position upstream of the head element; a recess formed on the surface of the insulating non-magnetic film, the front end of the heating wiring pattern being exposed in the recess; and a protection film formed on the surface of the insulating non-magnetic film.

The head slider allows the heating wiring pattern to get heated in response to supply of electric current to the heating wiring pattern. This results in expansion of the insulating non-magnetic film. The recess serves to bring the front end of the heating wiring pattern backward from the medium-opposed surface of the insulating non-magnetic film. The protection film is allowed to have a larger thickness within the recess rather than the protection film outside the recess. The front end of the heating wiring pattern is thus covered with the thicker portion of the protection film. Even if the heating wiring pattern or insulating non-magnetic film protrudes to contact with the recording medium, the heating wiring pattern is prevented from protruding out of the surface of the insulating non-magnetic film. The heating wiring pattern is thus prevented from receiving damages. In addition, the heating wiring pattern gets closer to the recording medium at a position upstream of the head element. Even if the head slider contacts with the recording medium, the insulating non-magnetic film covering over the heating wiring pattern is forced to contact with the recording medium. Since the head element is located at a position downstream of the heating wiring pattern, the head element is prevented from receiving damages. The head slider may be employed in a storage medium drive, for example.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the structure of a hard disk drive, HDD, as an example of a storage medium drive according to the present invention;

FIG. 2 is a perspective view schematically illustrating a flying head slider according to a first embodiment of the present invention;

FIG. 3 is a front view of the flying head slider observed at a medium-opposed surface;

FIG. 4 is a sectional view taken along the line 4-4 in FIG. 3;

FIG. 5 is an enlarged partial sectional view schematically illustrating the flying head slider during flight;

FIG. 6 is a graph showing the relationship between the protrusion amount of a lower shielding layer and the electric power of a heating wiring pattern;

FIG. 7 is an enlarged partial sectional view, corresponding to FIG. 4, schematically illustrating a flying head slider according to a second embodiment of the present invention;

FIG. 8 is an enlarged partial sectional view schematically illustrating the flying head slider during flight;

FIG. 9 is an enlarged partial sectional view, corresponding to FIG. 4, schematically illustrating a flying head slider according to a third embodiment of the present invention;

FIG. 10 is an enlarged partial sectional view schematically illustrating protrusion of a protection film;

FIG. 11 is an enlarged partial sectional view, corresponding to FIG. 4, schematically illustrating a flying head slider according to a fourth embodiment of the present invention; and

FIG. 12 is an enlarged partial sectional view schematically illustrating protrusion of a protection film.

### DESCRIPTION OF THE PREFERRED EMBODIMENTS

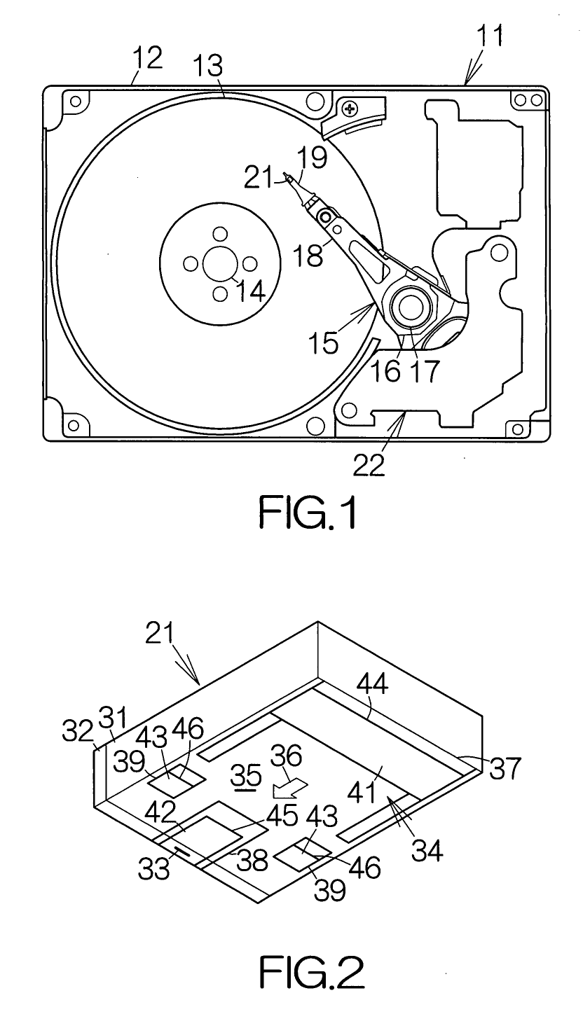

FIG. 1 schematically illustrates the structure of a hard disk drive, HDD, 11 as an example of a storage medium drive or a storage device according to the present invention. The hard disk drive 11 includes a box-shaped enclosure body 12 defining an inner space in the form of a flat parallelepiped, for example. The enclosure body 12 may be made of a metallic material such as aluminum, for example. Molding process may be employed to form the enclosure body 12. An enclosure cover, not shown, is coupled to the enclosure body 12. An inner space is defined between the enclosure body 12 and the enclosure cover. Pressing process may be employed to form the enclosure cover out of a plate material, for example. The enclosure body 12 and the enclosure cover in combination establish an enclosure.

At least one magnetic recording disk 13 as a storage medium is enclosed in the enclosure body 12. The magnetic recording disk or disks 13 are mounted on the driving shaft of a spindle motor 14. The spindle motor 14 drives the magnetic recording disk or disks 13 at a higher revolution speed such as 5,400 rpm, 7,200 rpm, 10,000 rpm, 15,000 rpm, or the like.

A carriage 15 is also enclosed in the enclosure body 12. The carriage 15 includes a carriage block 16. The carriage block 16 is supported on a vertical support shaft 17 for relative rotation. Carriage arms 18 are defined in the carriage block 16. The carriage arms 18 are designed to extend in the horizontal direction from the vertical support shaft 17. The carriage block 16 may be made of aluminum, for example. Extrusion molding process may be employed to form the carriage block 16, for example.

A head suspension 19 is fixed to the tip end of the individual carriage arm 18. The head suspension 19 is designed to extend forward from the tip end of the carriage arm 18. A predetermined urging force is applied to the head suspension 19 toward the surface of the magnetic recording disk 13. A flying head slider 21 is fixed to the tip end of the head suspension 19. A head element or electromagnetic transducer, not shown, is mounted on the flying head slider 21.

When the magnetic recording disk 13 rotates, the flying head slider 21 is allowed to receive an airflow generated along the rotating magnetic recording disk 13. The airflow serves to generate a positive pressure or a lift as well as a negative pressure on the flying head slider 21. The flying head slider 21 is thus allowed to keep flying above the surface of the magnetic recording disk 13 during the rotation of the magnetic recording disk 13 at a higher stability established by the balance between the urging force of the head suspension 19 and the combination of the lift and the negative pressure.

A power source such as a voice coil motor, VCM, 22 is coupled to the carriage block 16. The voice coil motor 22 serves to drive the carriage block 16 around the vertical support shaft 17. The rotation of the carriage block 16 allows the carriage arms 18 to swing. When the carriage arm 18 swings around the vertical support shaft 17 during the flight of the flying head slider 21, the flying head slider 21 is allowed to move along the radial direction of the magnetic recording disk 13. The electromagnetic transducer on the flying head slider 21 is positioned right above a target recording track on the magnetic recording disk 13 through the movement of the flying head slider 21.

FIG. 2 illustrates a specific example of the flying head slider 21. The flying head slider 21 includes a slider body 31 in the form of a flat parallelepiped, for example. A head protection film 32 is overlaid on the outflow or trailing end surface of the slider body 31. The aforementioned electromagnetic transducer 33 is incorporated in the head protection film 32. The electromagnetic transducer 33 will be described later in detail.

The slider body 31 may be made of a hard material such as Al₂O₃-Tic. The head protection film 32 is made of a relatively soft material such as Al₂O₃ (alumina). A medium-opposed surface or bottom surface 34 is defined over the slider body 31 so as to face the magnetic recording disk 13 at a distance. A flat base surface 35 as a reference surface is defined on the bottom surface 34. When the magnetic recording disk 13 rotates, airflow 36 flows along the bottom surface 34 from the inflow or front end toward the outflow or rear end of the slider body 31.

A front rail 37 is formed on the bottom surface 34 of the slider body 31. The front rail 37 stands upright from the base surface 35 of the bottom surface 34 near the inflow end of the slider body 31. The front rail 37 is designed to extend along the inflow end of the base surface 35 in the lateral direction of the slider body 31. A rear rail 38 is likewise formed on the bottom surface 34 of the slider body 31. The rear rail 38 stands upright from the base surface 35 of the bottom surface 34 near the outflow end of the slider body 31. The rear rail 38 is located at the intermediate position in the lateral direction of the slider body 31.

A pair of auxiliary rear rails 39, 39 is likewise formed on the bottom surface 34 of the slider body 31. The auxiliary rear rails 39, 39 stand upright from the base surface 35 of the bottom surface 34 near the outflow end of the slider body 31. The auxiliary rear rails 39, 39 are located along the sides of the base surface 35, respectively. The auxiliary rear rails 39, 39 are thus distanced from each other in the lateral direction of the slider body 31. The rear rail 38 is located in a space between the auxiliary rear rails 39, 39.

Air bearing surfaces 41, 42, 43 are defined on the top surfaces of the front, rear and auxiliary rear rails 37, 38, 39, respectively. Steps 44, 45, 46 connect the inflow ends of the air bearing surfaces 41, 42, 43 to the top surfaces of the rails 37, 38, 39, respectively. The bottom surface 34 of the flying head slider 21 is designed to receive the airflow 36 generated along the rotating magnetic recording disk 13. The steps 44, 45, 46 serve to generate a larger positive pressure or lift at the air bearing surfaces 41, 42, 43, respectively. Moreover, a larger negative pressure is induced behind the front rail 37 or at a position downstream of the front rail 37. The negative pressure is balanced with the lift so as to stably establish the flying attitude of the flying head slider 21.

A protection film, not shown, is formed on the surface of the slider body 31 at the air bearing surfaces 41, 42, 43, for example. The aforementioned electromagnetic transducer 33 has a read gap and a write gap exposed on the surface of the slider body 31 at a position downstream of the air bearing surface 42. The protection film covers over the read and write gaps of the electromagnetic transducer 33. The protection film may be made of diamond-like-carbon (DLC), for example. It should be noted that the flying head slider 21 may take any shape or form different from the described one.

FIG. 3 illustrates the bottom surface 34 of the flying head slider 21 in detail. The electromagnetic transducer 33 includes a write head 61 and a read head 62. As conventionally known, the write head 61 utilizes a magnetic field generated at a magnetic coil for writing binary data into the magnetic recording disk 13, for example. A magnetoresistive (MR) element such as a spin-valve film may be employed to form the read head 62. The read head 62 is usually designed to detect binary data based on variation in the electric resistance in response to the inversion of polarization in the magnetic field applied from the magnetic recording disk 13. It should be noted that a giant magnetoresistive (GMR) element or a tunnel-junction magnetoresistive (TMR) element may be employed to form the read head 62, for example.

The read head 62 includes a lower shielding layer 63 and an upper shielding layer 64. The lower shielding layer 63 is embedded in the head protection film 32. The upper shielding layer 64 is embedded in the head protection film 32 at a position downstream of the lower shielding layer 63. A magnetoresistive film 65 is embedded in the head protection film 32 between the upper and lower shielding layers 64, 63. The upper and lower shielding layers 64, 63 may be made of a magnetic material such as FeN, NiFe, or the like.

The lower shielding layer 63 is designed to extend backward from the front end exposed on the bottom surface 34 along a first imaginary plane 66 intersecting with the bottom surface 34. The upper shielding layer 64 is likewise designed to extend backward from the front end exposed on the bottom surface 34 along a second imaginary plane 67 parallel with the first imaginary plane 66. Here, the first and second imaginary planes 66, 67 are set perpendicular to the bottom surface 34. The gap between the upper and lower shielding layers 64, 63 determines a linear resolution of magnetic recordation on the magnetic recording disk 13 along the recording track.

The write head 61 includes upper and lower magnetic pole layers 69, 71. The front ends of the upper and lower magnetic pole layers 69, 71 are exposed at the air bearing surface 42. The lower magnetic pole layer 71 extends along a plane parallel to the upper shielding layer 64. A magnetic front end layer 72 is formed on the lower magnetic pole layer 71. The front end of the magnetic front end layer 72 is exposed at the air bearing surface 42. The upper and lower magnetic pole layers 69, 71 and the magnetic front end layer 72 may be made of FeN, NiFe, or the like. The upper and lower magnetic pole layers 69, 71 and the magnetic front end layer 72 in combination serve as a magnetic core of the write head 61.

The magnetic front end layer 72 is opposed to the upper magnetic pole layer 69. A non-magnetic gap layer 73 made of Al₂O₃ or the like is interposed between the upper magnetic pole layer 69 and the magnetic front end layer 72. As conventionally known, when a magnetic field is generated at the aftermentioned magnetic coil, the non-magnetic gap layer 73 serves to leak a magnetic flux out of the bottom surface 34 between the upper and lower magnetic pole layers 69, 71. The leaked magnetic flux forms a magnetic field for recordation. Specifically, a write gap is defined between the upper magnetic pole layer 69 and the magnetic front end layer 72.

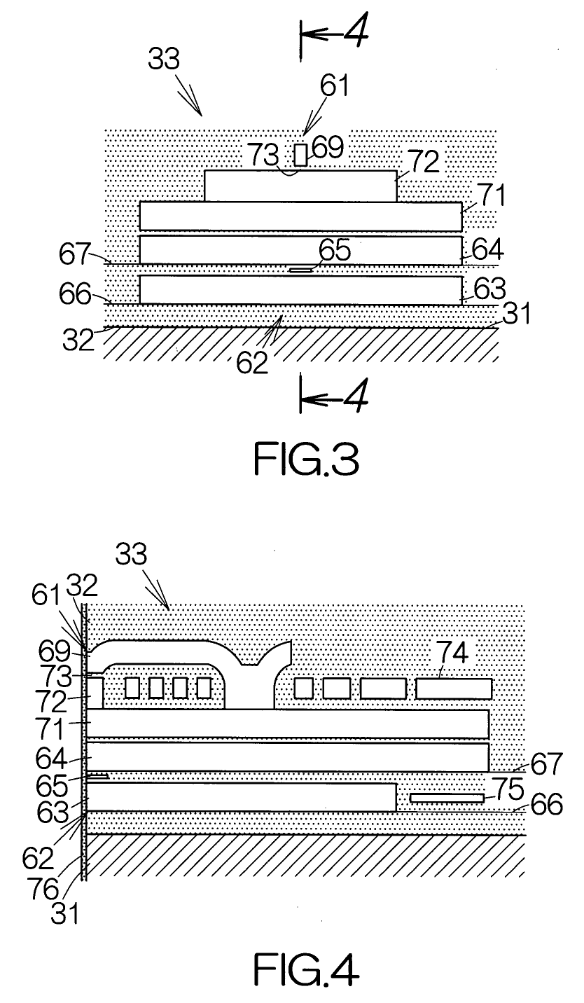

Referring also to FIG. 4, the magnetic coil, namely a thin film coil pattern 74, is formed on the lower magnetic pole layer 71. The thin film coil pattern 74 is embedded in the head protection film 32. The thin film coil pattern 74 may be made of Cu, for example. The aforementioned upper magnetic pole layer 69 is formed on the upper surface of the non-magnetic gap layer 73. The rear end of the upper magnetic pole layer 69 is magnetically connected to the rear end of the lower magnetic pole layer 71 at the center of the thin film coil pattern 74. The upper and lower magnetic pole layers 69, 71 in combination serve as a magnetic core extending through the center of the thin film coil pattern 74.

A heating wiring pattern 75 is embedded within the head protection film 32 at the back of the lower shielding layer 63. The heating wiring pattern 75 may be made of tungsten, for example. The heating wiring pattern 75 may extend in parallel with the first and second imaginary planes 66, 67, for example. The thickness of the heating wiring pattern 75 is set smaller than that of the lower shielding layer 63. Electric current is supplied to the heating wiring pattern 75. The heating wiring pattern 75 gets heated in response to the supply of electric current. This results in expansion of the lower shielding layer 63 in front of the heating wiring pattern 75. The lower shielding layer 63 is forced to protrude in this manner.

A protection film 76 is formed on the surface of the head protection film 32 as described above. The protection film 76 covers over the front end of the electromagnetic transducer 33. The protection film 76 may be made of diamond-like-carbon (DLC), for example. The thickness of the protection film 76 may be set at approximately 3 nm, for example. The protection film 76 serves to prevent the electromagnetic transducer 33 from corrosion.

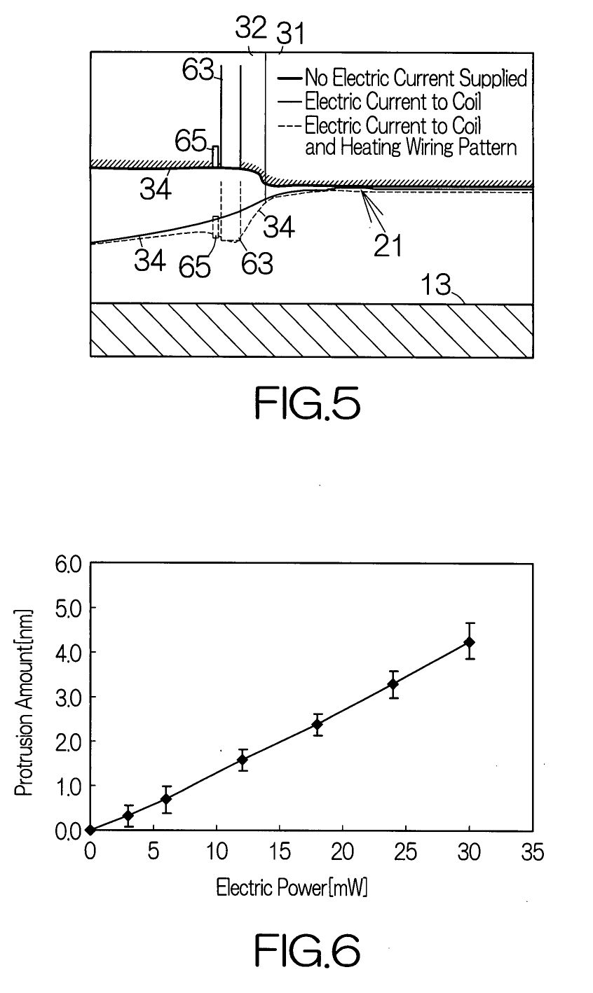

The flying head slider 21 is kept in a predetermined flying attitude during the rotation of the magnetic recording disk 13. As shown in FIG. 5, the lower shielding layer 63 fails to protrude when no electric current is supplied to the thin film coil pattern 74. The thin film coil pattern 74 gets heated in response to the supply of electric current. This results in protrusion of the write head 61. The entire electromagnetic transducer 33 is thus forced to protrude.

The lower shielding layer 63 is forced to protrude in response to the supply of electric current to the heating wiring pattern 75. The lower shielding layer 63 thus gets closer to the magnetic recording disk 13 at a position upstream of the magnetoresistive film 65. Even if the flying head slider 21 collides against the magnetic recording disk 13, the flying head slider 21 allows the lower shielding layer 63 to contact with the magnetic recording disk 13. Since the magnetoresistive film 65 is located at a position downstream of the slider body 31 than the lower shielding layer 63, the magnetoresistive film 65 is prevented from receiving damages.

The thickness of the heating wiring pattern 75 is set smaller than that of the lower shielding layer 63 in the flying head slider 21 as described above. The radiation of heat is thus minimized from the heating wiring pattern 75. Expansion of the head protection film 32 is suppressed as much as possible in the vicinity of the heating wiring pattern 75. Expansion of only the lower shielding layer 63 is thus induced in the flying head slider 21. Protrusion of the magnetoresistive film 65 is minimized.

Next, the present inventor has observed the relationship between the electric power of the heating wiring pattern 75 and the protrusion amount of the lower shielding layer 63. As shown in FIG. 6, it has been revealed that the protrusion amount of the lower shielding layer 63 increases in response to increase in the electric power of the heating wiring pattern 75. The protrusion amount of the lower shielding layer 63 was almost proportional to the electric power of the heating wiring pattern 75. It has been confirmed that the control on the electric power of the heating wiring pattern 75 can be utilized to control the protrusion amount of the lower shielding layer 63.

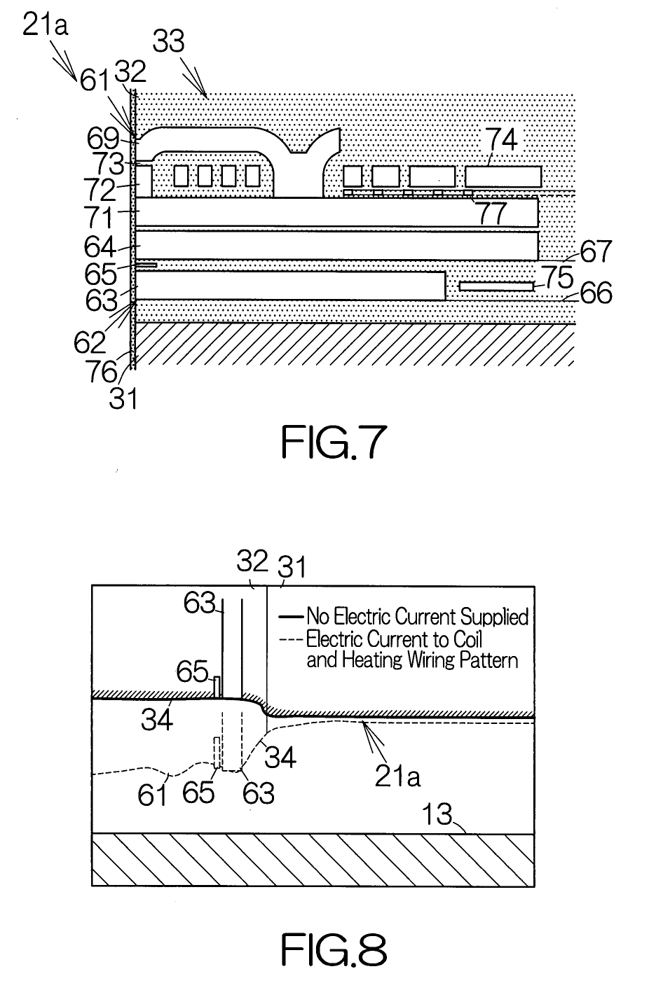

As shown in FIG. 7, a flying head slider 21a according to a second embodiment of the present invention may be employed in the hard disk drive 11 in place of the aforementioned flying head slider 21. A heating wiring pattern 77 is embedded in the head protection film 32 between the thin film coil pattern 74 and the lower magnetic pole layer 71 in the flying head slider 21a. The heating wiring pattern 77 may be made of tungsten, for example. The heating wiring pattern 77 serves as a first heating wiring pattern of the invention. The aforementioned heating wiring pattern 75 serves as a second heating wiring pattern of the invention. Like reference numerals are attached to the structure or components equivalent to those of the aforementioned flying head slider 21.

When binary data is to be written, the heating wiring pattern 77 is supplied with electric current in the flying head slider 21a. The heating wiring pattern 77 gets heated in response to the supply of electric current. This results in expansion of the write head 61. As shown in FIG. 8, the write head 61 is forced to protrude in this manner. The write head 61 is allowed to get closer to the magnetic recording disk 13. The lower shielding layer 63 is also forced to protrude. The flying head slier 21a is allowed to enjoy the advantages identical to those obtained in the aforementioned embodiment.

As shown in FIG. 9, a flying head slider 21b according to a third embodiment of the present invention may be employed in the hard disk drive 11 in place of the aforementioned flying head sliders 21, 21a. A recess 78 is formed on the surface of the head protection film 32 in the flying head slider 21b. The front end of the lower shielding layer 63 is exposed in the recess 78. Etching may be employed to form the recess 78, for example. An outer exposed flat surface is defined in the surface of the protection film 76 regardless of the formation of the recess 78. Like reference numerals are attached to the structure or components equivalent to those of the aforementioned flying head slider 21.

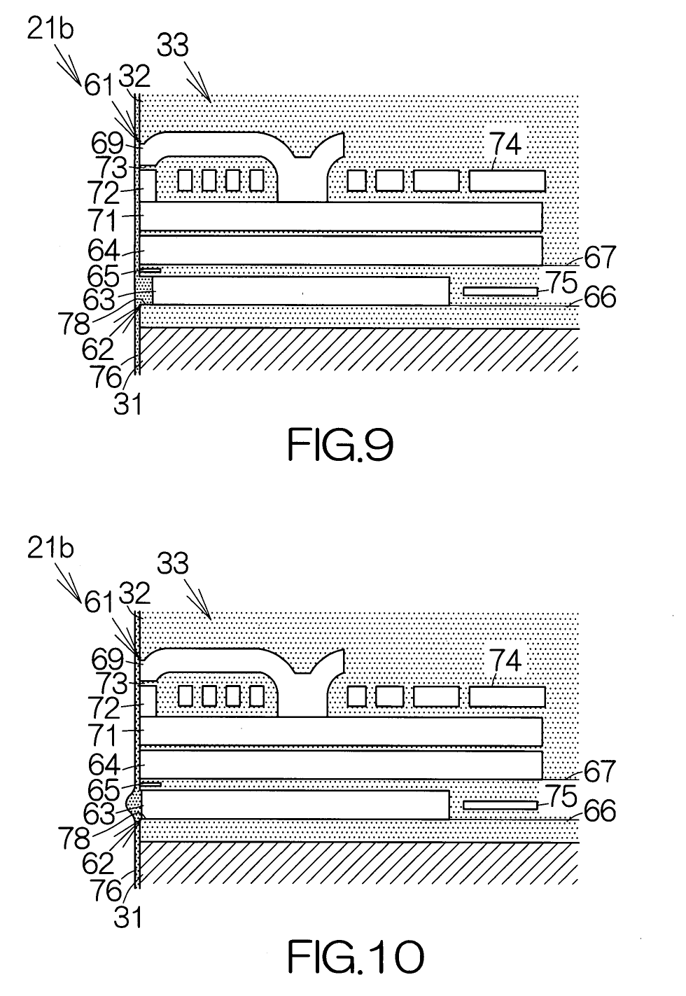

The recess 78 serves to bring the front end of the lower shielding layer 63 backward from the surface of the head protection film 32 in the flying head slider 21b. The protection film 76 has a larger thickness within the recess 78 rather than the protection film 76 outside the recess 78. The front end of the lower shielding layer 63 is thus covered with the thicker portion of the protection film 76. As shown in FIG. 10, even if the lower shielding layer 63 protrudes to contact with the magnetic recording disk 13, the lower shielding layer 63 is prevented from protruding out of the surface of the head protection film 32. The lower shielding layer 63 is thus prevented from receiving damages.

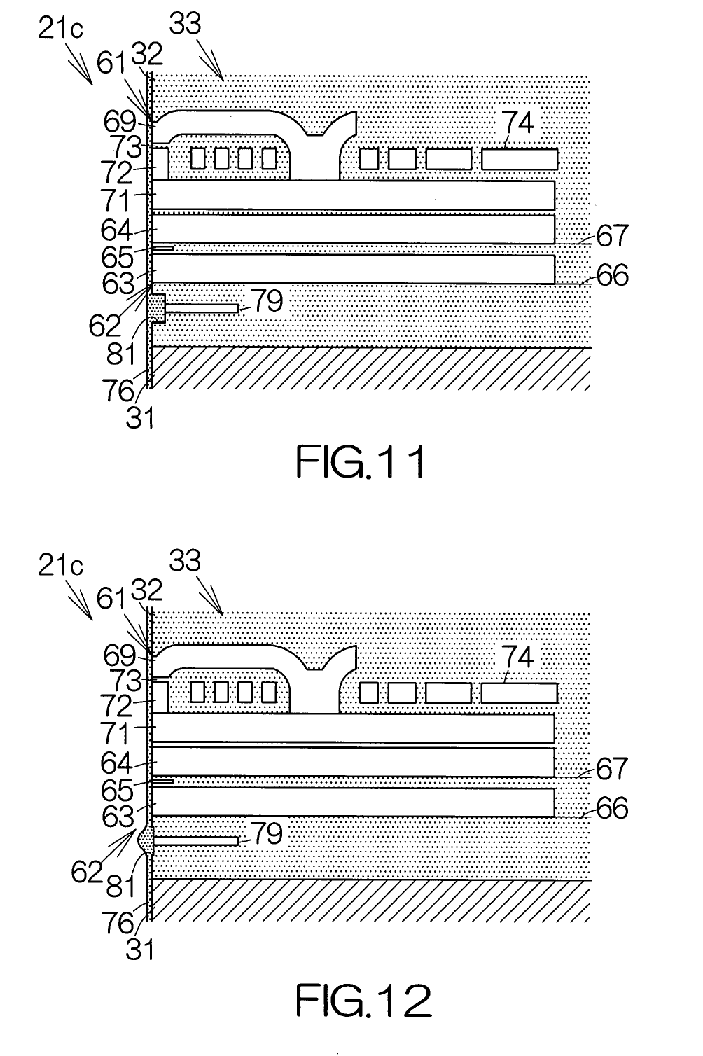

As shown in FIG. 11, flying head slider 21c according to a third embodiment of the present invention may be employed in the hard disk drive 11 in place of the aforementioned flying head sliders 21, 21a, 21b. A heating wiring pattern 79 is embedded in the head protection film 32 between the read head 62 and the slider body 31 in the flying head slider 21c. The heating wiring pattern 79 may be made of tungsten, for example. A recess 81 is formed on the surface of the head protection film 32. The front end of the heating wiring pattern 79 is exposed in the recess 81. An outer exposed flat surface is defined in the surface of the protection film 76 regardless of the formation of the recess 81.

The front end of the heating wiring pattern 79 is retreated from the surface of the head protection film 32 in the flying head slider 21c. The protection film 76 has a larger thickness within the recess 81 rather than the protection film 76 outside the recess 81. The front end of the heating wiring pattern 79 is thus covered with the thicker portion of the protection film 76. As shown in FIG. 12, the heating wiring pattern 79 is thus prevented from protruding out of the surface of the head protection film 32 even if the expansion of the heating wiring pattern 79 causes contact between the flying head slider 21c and the magnetic recording disk 13. The heating wiring pattern 79 is thus prevented from receiving damages.

What is claimed is:

1. A head slider comprising:
a slider body;
an insulating non-magnetic film overlaid on an outflow end surface of the slider body, the insulating non-magnetic film defining a medium-opposed surface opposed to a recording medium at a distance;
a lower shielding layer embedded in the insulating non-magnetic film, the lower shielding layer having a front end exposed at the medium-opposed surface of the insulating non-magnetic film, the lower shielding layer extending backward from the front end along a first imaginary plane intersecting with the medium-opposed surface;
an upper shielding layer embedded in the insulating non-magnetic film at a position downstream of the lower shielding layer, the upper shielding layer extending along a second imaginary plane parallel to the first imaginary plane;
a magnetoresistive film embedded in the insulating non-magnetic film at a position between the lower and upper shielding layers; and
a heating wiring pattern embedded in the insulating non-magnetic film at the back of the lower shielding layer.

2. The head slider according to claim 1, further comprising:
a recess formed on the medium-opposed surface of the insulating non-magnetic film, the front end of the lower shielding layer being exposed in the recess; and
a protection film formed on the medium-opposed surface of the insulating non-magnetic film, the protection film having an outer exposed flat surface.

3. A storage medium drive comprising:
an enclosure;
a recording medium enclosed in the enclosure; and
a head slider opposed to the recording medium within the enclosure, wherein
the head slider includes:
a slider body;
an insulating non-magnetic film overlaid on an outflow end surface of the slider body, the insulating non-magnetic film defining a medium-opposed surface opposed to the recording medium at a distance;
a lower shielding layer embedded in the insulating non-magnetic film, the lower shielding layer having a front end exposed at the medium-opposed surface of the insulating non-magnetic film, the lower shielding layer extending backward from the front end along a first imaginary plane intersecting with the medium-opposed surface;
an upper shielding layer embedded in the insulating non-magnetic film at a position downstream of the lower shielding layer, the upper shielding layer extending along a second imaginary plane parallel to the first imaginary plane;
a magnetoresistive film embedded in the insulating non-magnetic film at a position between the lower and upper shielding layers; and
a heating wiring pattern embedded in the insulating non-magnetic film at the back of the lower shielding layer.

4. A storage medium drive according to claim 3, further comprising:
a recess formed on the medium-opposed surface of the insulating non-magnetic film, the front end of the lower shielding layer being exposed in the recess; and
a protection film formed on the medium-opposed surface of the insulating non-magnetic film, the protection film having an outer exposed flat surface.

5. A head slider comprising:
a slider body;
an insulating non-magnetic film overlaid on an outflow end surface of the slider body;
a lower shielding layer embedded in the insulating non-magnetic film;
an upper shielding layer embedded in the insulating non-magnetic film at a position downstream of the lower shielding layer, the upper shielding layer extending in parallel with the lower shielding layer;
a magnetoresistive film embedded in the insulating non-magnetic film at a position between the lower and upper shielding layers; and
a heating wiring pattern embedded in the insulating non-magnetic film to cause expansion of only the lower shielding layer.

6. The head slider according to claim 5, further comprising:
a recess formed on a surface of the insulating non-magnetic film, the front end of the lower shielding layer being exposed in the recess; and
a protection film formed on the surface of the insulating non-magnetic film, the protection film having an outer exposed flat surface.

7. A storage medium drive comprising:
an enclosure;
a recording medium enclosed in the enclosure; and
a head slider opposed to the recording medium within the enclosure, wherein
the head slider includes:
a slider body;
an insulating non-magnetic film overlaid on an outflow end surface of the slider body;
a lower shielding layer embedded in the insulating non-magnetic film;
an upper shielding layer embedded in the insulating non-magnetic film at a position downstream of the lower shielding layer, the upper shielding layer extending in parallel with the lower shielding layer;
a magnetoresistive film embedded in the insulating non-magnetic film at a position between the lower and upper shielding layers; and
a heating wiring pattern embedded in the insulating non-magnetic film to cause expansion of only the lower shielding layer.

8. The storage medium drive according to claim 7, further comprising:
a recess formed on a surface of the insulating non-magnetic film, the front end of the lower shielding layer being exposed in the recess; and
a protection film formed on the surface of the insulating non-magnetic film, the protection film having an outer exposed flat surface.

9. A head slider comprising:
a slider body;
an insulating non-magnetic film overlaid on an outflow end surface of the slider body;
a lower shielding layer embedded in the insulating non-magnetic film;
an upper shielding layer embedded in the insulating non-magnetic film at a position downstream of the lower shielding layer, the upper shielding layer extending in parallel with the lower shielding layer;
a magnetoresistive film embedded in the insulating non-magnetic film at a position between the lower and upper shielding layers;
a write head embedded in the insulating non-magnetic film at a position downstream of the upper shielding layer;
a first heating wiring pattern embedded in the insulating non-magnetic film to cause expansion of the write head; and
a second heating wiring pattern embedded in the insulating non-magnetic film to cause expansion of the lower shielding layer.

10. A storage medium drive comprising:
an enclosure;
a recording medium enclosed in the enclosure; and
a head slider opposed to the recording medium within the enclosure, wherein
the head slider includes:
a slider body;
an insulating non-magnetic film overlaid on an outflow end surface of the slider body;
a lower shielding layer embedded in the insulating non-magnetic film;
an upper shielding layer embedded in the insulating non-magnetic film at a position downstream of the lower shielding layer, the upper shielding layer extending in parallel with the lower shielding layer;
a magnetoresistive film embedded in the insulating non-magnetic film at a position between the lower and upper shielding layers;
a write head embedded in the insulating non-magnetic film at a position downstream of the upper shielding layer;
a first heating wiring pattern embedded in the insulating non-magnetic film to cause expansion of the write head; and
a second heating wiring pattern embedded in the insulating non-magnetic film to cause expansion of the lower shielding layer.

11. A head slider comprising:
a slider body;
an insulating non-magnetic film overlaid on an outflow end surface of the slider body;
a head element embedded in the insulating non-magnetic film;
a heating wiring pattern embedded in the insulating non-magnetic film at a position upstream of the head element;
a recess formed on a surface of the insulating non-magnetic film, a front end of the heating wiring pattern being exposed in the recess; and
a protection film formed on the surface of the insulating non-magnetic film.

12. A storage medium drive:
an enclosure;
a recording medium enclosed in the enclosure; and
a head slider opposed to the recording medium within the enclosure, wherein
the head slider includes:
a slider body;
an insulating non-magnetic film overlaid on an outflow end surface of the slider body;
a head element embedded in the insulating non-magnetic film;
a heating wiring pattern embedded in the insulating non-magnetic film at a position upstream of the head element;
a recess formed on a surface of the insulating non-magnetic film, a front end of the heating wiring pattern being exposed in the recess; and
a protection film formed on the surface of the insulating non-magnetic film.
